(19) United States
(12) Patent Application Publication
(10) Pub. No.: US 2012/0182241 A1
(43) Pub. Date: Jul. 19, 2012

(54) DIGITAL DISPLAY DEVICE, IN PARTICULAR FOR PREPARING A PATH

(76) Inventors: Loic Molino, Sartrouville (FR); Christophe Regniez, Suresnes (FR)

(21) Appl. No.: 13/388,051

(22) PCT Filed: Jul. 19, 2010
(86) PCT No.: PCT/FR10/51508

§ 371 Date: Apr. 3, 2012

(30) Foreign Application Priority Data
Jul. 30, 2009 (FR) 0955358

(51) Int. Cl. G06F 3/041

(52) U.S. Cl. 345/173

(57) ABSTRACT

The invention relates to a digital display device, comprising a display for a scene, a means for displaying a virtual tool for selecting at least one point of the scene, and a touch-sensitive means for controlling said screen coupled to the display means in order to move said virtual tool on said scene. The virtual selection tool includes at least one first display area for locating said point on said scene, and a second display area for the touch-sensitive control of the movement of said tool on said scene. The first and second display areas are separate and interconnected with one another.

The present invention relates to a digital display device, in particular for preparing a path, for example a flight plan.

Already known in the state of the art is a digital display device of the type comprising:

a display for at least one scene, for example a roadmap or a map of aeronautic paths,

means for displaying a virtual tool for selecting at least one point of said scene, and

touch-sensitive means for controlling said screen coupled to the display means in order to move said virtual tool on said scene.

Traditionally, the virtual selection tool can be moved on the scene, for example so as to define a path or a flight plan.

The touch-sensitive means for controlling the screen in particular make it possible to move said virtual tool over the scene with optimal ergonomics, as a function of the movement of the finger on the touch-sensitive screen.

However, it is sometimes difficult to manipulate the virtual tool so as to position the point on the scene. In fact, the selected point generally being covered by the user's finger or hand, it is difficult for that user to observe the exact position of the point without removing his hand. Furthermore, the user's finger has too large a contact surface with the screen to make it possible to precisely define the position of a point.

The invention in particular aims to resolve these drawbacks by providing a digital display device of the aforementioned type allowing precise selection of points on the scene.

To that end, the invention relates to a digital display device of the aforementioned type, wherein the virtual selection tool includes at least one first display area for locating said point on said scene, and a second display area for the touch-sensitive control of the movement of said tool on said scene, the first and second display areas being separate and interconnected with one another.

The invention in particular makes it possible to move the virtual tool without placing the finger on the selected point, but rather by placing it on the second display area.

Since this display area is interconnected with the first one, moving the finger drives the first area at the same time as the second area, and therefore drives the selected point.

Furthermore, since this second display area is separate from the first area that includes the selected point, the user's finger and hand do not cover that point during movement thereof.

As a result, the user can observe the movement and precise positioning of the selected point when he moves it tactilely on the scene.

Furthermore, the surface of the finger in contact with the screen has no impact on the precision of the positioning of the selection point, since that finger is placed on the second display area, the form of which is of little importance, and makes it possible to move the point in an interconnected manner.

Optionally, the digital display device comprises one or more of he following features, considered independently or in combination.

The digital display device comprises means for coupling the movement of the virtual tool to a tactile movement, so that the amplitude of the movement of the virtual tool depends on the amplitude of the tactile movement, this function being such that the movement amplitude of the virtual tool is less than the amplitude of the tactile movement when the latter is non-zero. This feature makes it possible to perform a precise, small-amplitude movement of the point.

The first display area is provided with crosshairs centered on the point. These crosshairs make it possible to view the position of the point precisely.

The display means includes a function for magnifying the first display area, this magnification function being independent of the scale of the displayed scene. Owing to this magnification function, it is possible to position the point precisely. Furthermore, since this magnification function is independent of the scale of the displayed scene, and only occurs in the first display area, the user can keep an overall view of the scene during magnification. Furthermore, the magnification function is preferably provided so that all of the components displayed in the first display area remain displayed in that first display area after magnification.

The first display area is round. In this way, this area can be observed in the same way from all directions.

The virtual tool comprises a control menu shown at the periphery of the first display area. Such positioning of the control menu allows the user to view all tabs of the menu, even if his finger is placed on the touch-sensitive screen.

The control menu comprises at least one tab intended to call on one or more of the following instructions when said tab is activated by touch: display of a virtual keyboard on the touch-sensitive screen, display of information, such as coordinates, concerning the area of the scene where the virtual tool is located, or display of an object on the map, for example chosen from a menu.

The display means is capable of displaying a trajectory between a point of origin and the point selected by the virtual tool.

The display means is capable of displaying, around the first display area, a wheel provided with a reference making it possible to define an arrival direction of the trajectory at the point selected by the virtual tool.

The invention also relates to software for displaying a scene on a touch-sensitive screen, of the type comprising:

instructions for displaying a virtual tool for selecting at least one point of said scene, and

instructions for coupling a tactile command of said screen to the movement of the virtual tool on said scene,

wherein the display instructions are such that the virtual selection tool comprises at least:

a first display area for locating said point on said scene, and

a second display area for the tactile control of the movement of said tool on said scene,

the first and second display areas being separate and interconnected with one another.

The invention will be better understood upon reading the following description, provided solely as an example and done in reference to the appended figures, in which:

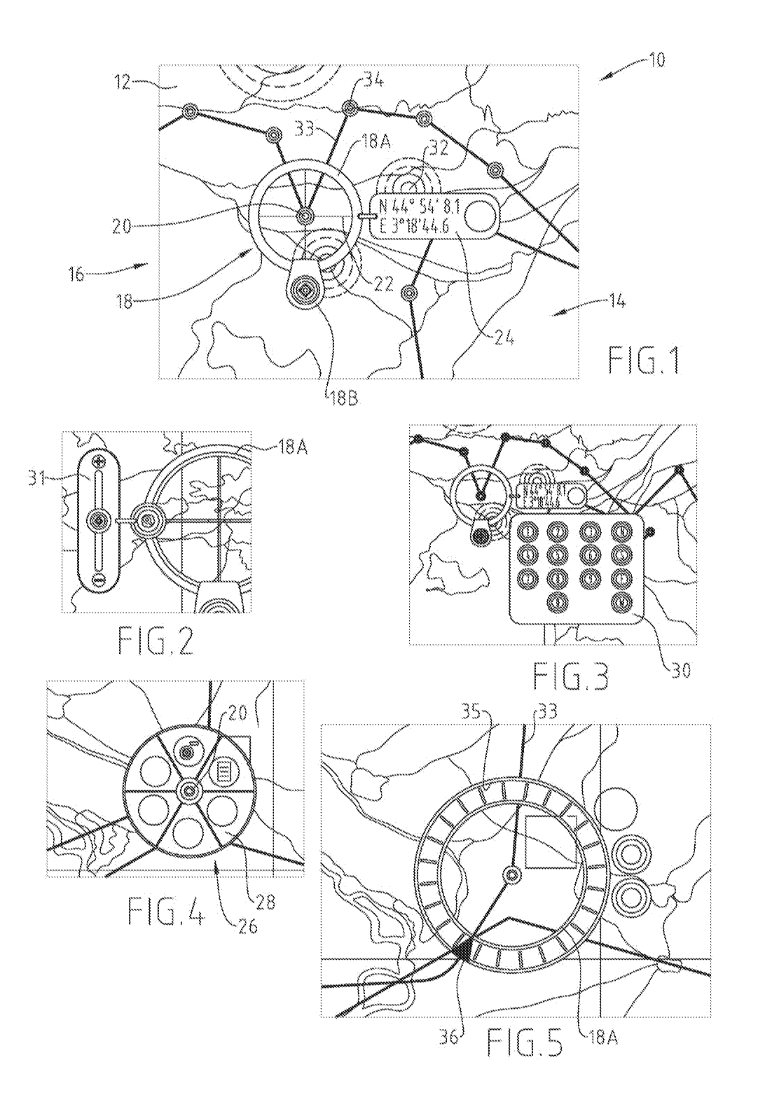

FIG. 1 shows a display screen of a scene of a digital display device according to one embodiment of the invention;

FIGS. 2 to 5 show various functionalities of the digital display device of FIG. 1.

The figures show a digital display device 10 comprising a display screen 12 for at least one scene 14.

In the illustrated example, the scene 14 is a geographical map, the digital display device being intended to display a trajectory on the map 14, for example a flight plan in the context of preparation for a mission.

To that end, the digital device 10 comprises means 16 for displaying a virtual tool 18 for selecting at least one point 20 of the scene 14.

The display screen 12 is a touch-sensitive screen, i.e. including tactile means for controlling said screen coupled to the display means 16 to move the virtual tool 18 on the scene 14, by moving one of the user's fingers in contact with the screen 12.

This touch-sensitive screen 12 is of the traditional type, provided with means making it possible to localize the user's finger and its movements on the screen. The digital device 10 also comprises a traditional computer coupled to the screen 12, the screen 12 serving as interface between the user and said computer.

The virtual selection tool 18 includes at least one first display area 18A to locate the point 20 on the scene 14. For example, the first display area 18A is round, and provided with crosshairs 22 centered on the point 20.

The virtual selection tool 18 also comprises a second display area 18B for the tactile of the movement of the tool 18 on the scene 14.

The first 18A and second 183 display areas are separate and interconnected. Thus, in order to move the point 20 on the scene 14, the user places a finger on the second display area 18B. Moving the finger drives the movement of the second display area 18B, situated under the finger, traditionally. This display area 183 being interconnected with the first display area 18A, this first display area 18A, and consequently the point 20, are also driven by moving the finger.

The user can therefore move the point 20 without concealing it with his finger, while also ensuring precise positioning of that point 20 on the scene 14.

It will be noted that the virtual tool 18 can comprise other display areas, for example a third display area 24, which preferably can be hidden, displaying the coordinates of the point 20. In the case where the scene 14 is a geographical map, these coordinates are the longitude and latitude of the point 20.

The virtual tool 18 preferably comprises a control menu 26 shown at the periphery of the first display area. This control menu 26 can be displayed continuously or upon request by the user, as shown in FIG. 4. It will be noted that this control menu 26 is preferably round, which allows optimal ergonomics and makes it possible not to conceal the point 20 as well as the objects near that point 20.

The control menu 26 comprises at least one tab 28 intended to call on an instruction when said tab 28 is activated by touch. For example, one tab 28 makes it possible to display a virtual keyboard 30 on the touch-sensitive screen when it is activated by touch, as shown in FIG. 3. This virtual keyboard 30 for example makes it possible to enter characters to complete information on the designated objects. For example, the virtual keyboard makes it possible to fill in coordinates for the scene.

Another tab 28 may make it possible to display or hide the third display area 24, comprising information, for example the coordinates of the selected point 20.

Another tab 28 may call on a magnification function of the first display area 18A, this magnification function being independent of the scale of the displayed scene, as shown in FIG. 2. Thus, only the scene displayed in the first display area 18A undergoes the magnification function, which makes it possible to position the point 20 on the scene, while keeping an overall view of the scene outside the first display area 18A. Preferably, a strip 31 allowing the user to choose the magnification scale is displayed near the first display area 18A.

Another tab 28 can call on a reduced amplitude movement function of the point 20 as a function of the amplitude of the movement of the user's finger. By activating that function, the movement of the virtual tool 18 becomes a function of the amplitude of the tactile movement, this function being such that the amplitude of the virtual tool 18 is smaller than the amplitude of said tactile movement when said amplitude is non-zero. This function allows a more precise movement of the virtual tool 18 over small amplitudes.

Lastly, another example of a tab of the control menu may make it possible to display an object 32 on the map, for example chosen from a secondary menu. The user can thus indicate the position of selected objects on the scene, for example obstacles or targets.

As shown in FIG. 1, the display means are capable of displaying a trajectory 33 between a point of origin 34 and the point 20 selected by the virtual tool 18. It is thus possible to produce a complete trajectory through a succession of a plurality of points positioned on the scene 14.

Preferably, the display means are capable of displaying, around the first display area 18A, a wheel 35 provided with a reference 36 making it possible to define, for example, an arrival direction of the trajectory 33 at the selected point 20, as shown in FIG. 5. This wheel 35 makes it possible to determine the shape of the trajectory 33 precisely.

In light of the preceding description, it appears clearly that the display device 10 according to the invention enables, with natural ergonomics, a very precise selection of points on a scene.

It will be noted that the invention is not limited to the embodiment described above, but could comprise additional functionalities without going beyond the scope of the invention.

### LIST OF REFERENCES

10: Digital display device

12: Display screen

14: Scene

16: Display means

18: Virtual tool

18A: First display area

18B: Second display area

20: Point of the scene

22: Crosshairs

24: Third display area

26: Control menu

28: Tab

30: Virtual keyboard

31: Strip

32: Object

33: Trajectory

34: Point of origin of the trajectory 33

35: Wheel

36: Reference of the wheel 35

1. A digital display device of the type comprising:
a display for at least one scene,
means for displaying a virtual tool for selecting at least one point of said scene, and
touch-sensitive means for controlling said screen coupled to the display means in order to move said virtual tool on said scene, wherein said virtual selection tool includes at least:
one first display area for locating said point on said scene, and
a second display area for the touch-sensitive control of the movement of said tool on said scene,
said first and second display areas being separate and interconnected with one another.

2. The digital display device according to claim 1, comprising means for coupling the movement of the virtual tool to a tactile movement, so that the amplitude of the movement of the virtual tool depends on the amplitude of the tactile movement, this function being such that the movement amplitude of the virtual tool is less than the amplitude of the tactile movement when the latter is non-zero.

3. The digital display device according to claim 1, wherein the first display area is provided with crosshairs centered on the point.

4. The digital display device according to claim 3, wherein the display means includes a function for magnifying the first display area, this magnification function being independent of the scale of the displayed scene.

5. The digital display device according to claim 3, wherein the first display area is round.

6. The digital display device according to claim 1, wherein the virtual tool comprises a control menu shown at the periphery of the first display area.

7. The digital display device according to claim 6, wherein the control menu comprises at least one tab intended to call on one or more of the following instructions when said tab is activated by touch:
display of a virtual keyboard on the touch-sensitive screen,
display of information, such as coordinates, concerning the area of the scene where the virtual tool is located, or
display of an object on the map, for example chosen from a menu.

8. The digital display device according to claim 1, wherein the display means is capable of displaying a trajectory between a point of origin and the point selected by the virtual tool.

9. The digital display device according to claim 8, wherein the display means is capable of displaying, around the first display area, a wheel provided with a reference making it possible to define an arrival direction of the trajectory at the point selected by the virtual tool.

10. Software for displaying a scene on a touch-sensitive screen, of the type comprising:
instructions for displaying a virtual tool for selecting at least one point of said scene, and
instructions for coupling a tactile command of said screen to the movement of the virtual tool on said scene,
wherein the display instructions are such that the virtual selection tool comprises at least:
a first display area for locating said point on said scene, and
a second display area for the tactile control of the movement of said tool on said scene,
said first and second display areas being separate and interconnected with one another.
